(19) United States
(12) Patent Application Publication
(10) Pub. No.: US 2025/0252305 A1
(43) Pub. Date: Aug. 7, 2025

(54) Multi-Modal Diffusion with Mixture of Timesteps

(71) Applicant: Google LLC, Mountain View, CA (US)

(72) Inventors: Krishna Somandepalli, New York, NY (US); Jacob Charles Walker, London (GB); Alonso Martinez, Berkeley, CA (US); Lijun Yu, Pittsburgh, PA (US); Brendan Wesley Jou, New York, NY (US); José Lezama Torres de la Llosa, Atlanta, GA (US); Agrim Gupta, Stanford, CA (US); Lu Jiang, Saratoga, CA (US); Gwanghyun Kim, Seoul (KR); Yu-Chuan Su, Kirkland, WA (US)

(21) Appl. No.: 19/044,073

(22) Filed: Feb. 3, 2025

Related U.S. Application Data
(60) Provisional application No. 63/548,776, filed on Feb. 1, 2024.

(51) Int. Cl. G06N 3/08; G06N 3/0455; G06T 5/70

(52) U.S. Cl. CPC G06N 3/08; G06N 3/0455; G06T 5/70

(57) ABSTRACT

Provided are techniques for training a denoising diffusion model on multi-modal data which leverage a timestep vector with a mixture of timestep values.

### RELATED APPLICATIONS

This application claims priority to and the benefit of U.S. Provisional Patent Application No. 63/548,776, filed Feb. 1, 2024. U.S. Provisional Patent Application No. 63/548,776 is hereby incorporated by reference in its entirety.

### FIELD

The present disclosure relates generally to machine learning. More particularly, the present disclosure relates to a unified diffusion framework for multi-modal sequence generation.

### BACKGROUND

In the field of machine learning, the generation of multi-modal data, such as audiovisual content, presents a significant technical challenge. Traditional approaches to multi-modal data generation often necessitate training separate diffusion models for each combination of modalities and tasks. This requirement stems from the fact that each task, such as audio-to-video generation or video-to-audio interpolation, may have unique conditional distributions that must be learned independently. As a result, a significant amount of computational power is expended in training and maintaining each of these multiple models, each tailored to a specific task or set of modalities.

Furthermore, the use of fixed diffusion timesteps in the forward diffusion process of prior art models imposes a limitation on the flexibility and adaptability of the model to different types of data and conditions. This limitation is particularly pronounced when dealing with multi-modal data, where different modalities may require different levels of noise perturbation and temporal resolution to achieve optimal generation results. As a result, models may either overfit to certain portions of the data or fail to capture the nuances of others, leading to repeated training iterations and fine-tuning, further escalating computational costs.

Moreover, existing diffusion models for multi-modal generation are typically designed to handle either unconditional joint generation or conditional generation. However, these models are limited in their ability to effectively learn and generate data across multiple modalities and time-slices, especially when temporal dynamics are included. For example, the generation of a video sequence with corresponding audio requires the model to understand and capture the temporal synchronization between the visual and auditory elements, a task that poses a technical problem due to the complex interplay between different modalities over time.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to train a denoising diffusion model on multi-modal data. The method includes obtaining, by a computing system comprising one or more computing devices, input data comprising a plurality of input data elements, wherein the plurality of input data elements correspond to at least two different data modalities and at least two different time-slices. The method includes determining, by the computing system, a timestep vector comprising a plurality of timestep values respectively for the plurality of input data elements, wherein the plurality of timestep values comprise at least two different values. The method includes adding, by the computing system, a respective set of noise to each of the plurality of input data elements to generate a plurality of noised data elements, wherein a perturbation level of the respective set of noise that is added to each input data element to generate the corresponding noised data element is controlled by the timestep value provided for such input data element by the timestep vector. The method includes processing, by the computing system, the plurality of noised data elements with the denoising diffusion model to generate a plurality of predicted noise elements respectively for the plurality of noised data elements. The method includes modifying, by the computing system, one or more values of one or more parameters of the denoising diffusion model based on a loss function that compares the plurality of predicted noise elements with the sets of noise that were added to the plurality of input data elements.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 provides a graphical diagram of an example training framework according to example embodiments of the present disclosure.

FIG. 2 provides graphical depictions of example timestep strategies or types according to example embodiments of the present disclosure.

FIG. 3 provides a graphical diagram of an example application of cross-modal generation according to example embodiments of the present disclosure.

FIG. 4 provides a graphical diagram of an example application of multi-modal completion according to example embodiments of the present disclosure.

FIG. 5 provides a graphical diagram of an example multi-modal classifier-free guidance approach according to example embodiments of the present disclosure.

FIG. 6 provides a graphical diagram of another example multi-modal classifier-free guidance approach according to example embodiments of the present disclosure.

FIG. 7 provides a graphical diagram of an example AV-transformer model according to example embodiments of the present disclosure.

FIG. 8A depicts a block diagram of an example computing system according to example embodiments of the present disclosure.

FIG. 8B depicts a block diagram of an example computing device according to example embodiments of the present disclosure.

FIG. 8C depicts a block diagram of an example computing device according to example embodiments of the present disclosure.

Reference numerals that are repeated across plural figures are intended to identify the same features in various implementations.

### DETAILED DESCRIPTION

The present disclosure introduces a unified diffusion framework for multi-modal data generation. Prior techniques for multi-modal diffusion models, such as text-to-image, text-to-video, and text-to-speech applications, have been limited in their scope, often supporting only a single task and requiring separate models for each task variation. This can be impractical and inefficient, particularly when dealing with variable data such as videos.

The present disclosure addresses these limitations by proposing a single model that can learn diverse conditional distributions, supporting numerous task variations. This is achieved by applying variable diffusion timesteps across the multi-modal space, for example per time-slice and/or per-modality, which enables a single diffusion model to learn arbitrary conditional distributions. The proposed training approach, which can in some implementations be referred to as Mixture of Diffusion Timesteps (MoDT), has several advantages over previous approaches. It requires minimal modifications to the original diffusion denoising objective, simplifying implementation. It can perform zero-shot inference given task specification without any inference-time modifications. Furthermore, it inherently learns diverse conditional distributions, allowing for easy integration of classifier-free guidance.

In one particular example, the proposed technology can be applied to multi-modal video generation with audio and video modalities by developing an audiovisual latent diffusion model (which may be referred to as “AV-LDM”). To handle the computational complexity associated with high-dimensional data modalities (e.g., audio and video signals), some example diffusion models proposed herein can be implemented in a latent space by leveraging the low-dimensional latent spaces learned by pre-trained encoders and decoders (e.g., the MAGVIT-v2 model for video and the SoundStream model for audio). The temporal structure preserved in these latent space representations enables the application of variable diffusion timesteps, a fundamental aspect of the proposed framework. Another aspect of the present disclosure is directed to AV-Transformer, which is a transformer-based noise prediction network introduced to implement denoising in AV-LDM.

The present disclosure demonstrates the versatility of the task-agnostic diffusion framework across a range of audiovisual generation tasks, outperforming conventional methods. Notably, the framework can generate temporally synchronized multi-modal distributions consistent with the input condition.

More particularly, example aspects of the present disclosure are directed to techniques for training a denoising diffusion model on multi-modal data. A first step in an example training method can include obtaining input data comprising a plurality of input data elements. These data elements correspond to at least two different data modalities and at least two different time-slices. For example, for video data, the data modalities can be visual and audio, and the time-slices can be the time intervals at which the data is captured.

Example training techniques use a unique approach of parameterizing the diffusion timestep in the forward diffusion process. Instead of using a fixed diffusion timestep strategy, the training techniques can apply variable timesteps across different data modalities and/or time-slices. This approach allows a single diffusion model to learn various conditional distributions, making it a more flexible and efficient solution for tasks including multi-modal data.

More particularly, the term “time-slice” refers to a single unit in time of the inputs, which represents a specific moment or interval within the data sequence, such as a frame in a video or a segment in an audio clip. Each time-slice is a discrete snapshot that captures the state of the multi-modal data at that particular point in time. On the other hand, “timestep” refers to the parameter in the diffusion process that controls the progression of noise addition or removal during model training or inference. Timesteps are used to gradually perturb or denoise the data, dictating the amount of noise to be added or predicted to be removed at each step of the diffusion process.

Thus, after receiving the input data elements, the next step in the training method can include determining a timestep vector comprising a plurality of timestep values respectively for the plurality of input data elements. According to an aspect of the present disclosure, these timestep values can include at least two different values.

In particular, the diffusion model can utilize a timestep vector to control the amount of noise added to each input data element. Each element of the timestep vector can correspond to an input data element and can control the perturbation level of the noise added to that element.

This timestep vector can have a number of different types or designs. For instance, the timestep vector can provide a different timestep value for each data modality, with consistent values across time-slices. Alternatively, the timestep vector can provide a different timestep value for each time-slice, with consistent values across different data modalities.

In another implementation of the present disclosure, the timestep vector can provide a unique timestep value for each input data element. This method allows for the greatest level of control over the noise added to each input data element. The timestep values in the vector can be determined in several ways, including random sampling or selecting a timestep vector type from a group including per-modality, per-time-slice, and per-time-slice and per-modality timestep vectors.

The training approach then includes adding a respective set of noise to each of the plurality of input data elements to generate a plurality of noised data elements. The perturbation level of the respective set of noise that is added to each input data element is controlled by the timestep value provided for such input data element by the timestep vector.

The plurality of noised data elements are then processed with the denoising diffusion model to generate a plurality of predicted noise elements. For instance, the denoising diffusion model can predict the noise that would need to be removed from each noised data element to reconstruct the original input data element.

The training system can then modify one or more values of one or more parameters of the denoising diffusion model based on a loss function. This loss function compares the plurality of predicted noise elements with the sets of noise that were added to the plurality of input data elements. For example, the parameters of the denoising diffusion model can be adjusted (e.g., based on a gradient of the loss function) so as to minimize the difference between the predicted and actual noise elements.

The present disclosure's framework is particularly beneficial for tasks including multi-modal data, such as audio and visual data. In some implementations, the input data elements can be latent space representations, which can be generated using pre-trained modality-specific encoder models. This allows the model to effectively handle high-dimensional audio and visual signals, making it a powerful tool for tasks such as multi-modal video generation.

Once trained, the denoising diffusion model can be used in a computing system to perform a variety of tasks. For instance, the model can perform unconditioned multi-modal data generation, generating data for multiple modalities simultaneously. Alternatively, the model can perform multi-modal data continuation, generating data conditioned on unimodal or multi-modal conditioning data.

The denoising diffusion model can also be used for data interpolation tasks. In this case, the model generates unimodal or multi-modal data conditioned on unimodal or multi-modal conditioning data. This allows the model to fill in gaps in the input data, creating a complete and coherent output.

The present disclosure also includes a method for performing classifier-free guidance. In this method, an unconditional run can include fully noising any conditioning data. This technique enhances the quality of samples produced by the model, making it a valuable tool for tasks such as text-to-image and text-to-video applications.

Thus, the present disclosure provides a unified diffusion framework that can learn a broad range of conditional distributions in multi-modal data using a single model. This approach surpasses other baselines at generating samples that are temporally and perceptually consistent with the conditioning input, making it a promising solution for a variety of cross-modal and multi-modal interpolation tasks.

The proposed framework provides a number of technical effects and advantages over the prior art. As one example technical effect, the present disclosure provides enhanced flexibility in temporal and modality-specific noise perturbation. The present disclosure introduces a novel approach to parameterizing the diffusion timestep in the forward diffusion process, utilizing variable timesteps across different data modalities and/or time-slices. This technical solution provides the technical effect of enabling the diffusion model to adaptively handle the specific requirements of various data modalities and temporal dynamics, thereby improving the model's flexibility and efficiency in generating high-quality multimodal data. This addresses the technical problem of fixed timestep limitations in prior art diffusion models, which could not adequately capture the nuances of multimodal synchronization.

As another example technical effect, the present disclosure provides efficient utilization of computational resources. By employing a single diffusion model capable of learning diverse conditional distributions, the present disclosure achieves the technical effect of reducing the need for multiple models tailored to specific tasks or sets of modalities. This technical solution contributes to a more efficient utilization of computational resources, solving the technical problem of impracticality and inefficiency associated with training and maintaining multiple separate models for each task variation in multimodal data generation.

As another example technical effect, the present disclosure provides simplification of model implementation. The present disclosure's framework simplifies the implementation of the diffusion denoising objective, providing the technical effect of reducing the complexity of model development and deployment. This technical solution addresses the technical problem of prior art models that required complex modifications and fine-tuning to adapt to different tasks and conditions.

As another example technical effect, the present disclosure provides improved quality of generated samples. This technical effect addresses the technical problem of suboptimal sample quality in prior art multimodal diffusion models, particularly in tasks that require high fidelity and temporal synchronization, such as audiovisual video generation.

The proposed unified diffusion framework can be employed to handle various combinations of input and output modalities. The framework's flexibility allows it to handle a wide array of tasks by learning conditional distributions across arbitrary modalities.

One example application is audio-to-video generation. In this modality combination, the input is an audio modality, and the output is a video modality. For instance, the input may be an audio clip or file of a musical performance, and the output would be a corresponding video sequence showing musicians playing the instruments in sync with the audio. The framework would generate the visual content conditioned on the audio input, ensuring that the movements of the musicians are temporally aligned with the music.

Video is commonly defined as a multimedia form that encompasses a sequence of image frames, which, when played in succession at a certain frame rate, create the illusion of motion. Often, audio tracks are synchronized with these frames to provide an auditory dimension that complements the visual content, enhancing the viewer's experience. Additionally, textual data, such as subtitles or captions, may be associated with some or all of the frames to convey dialogue, provide context, or offer translations, thereby making the content more accessible and informative.

Another example application is video-to-audio generation. In this example, the input can be a video modality, while the output is an audio modality. In this case, the input could be a silent video clip of a person playing the piano, and the output would be the generated audio of piano music, synced to movements of the player in the video. The framework learns to infer the audio from the visual cues included in the video.

Another example application is audiovisual continuation. For this example, both audio and video modalities serve as inputs, and the output is a continuation of the same modalities. An example input could be a brief segment of a movie scene with both audio and video, and the output would be the subsequent scene continuation, maintaining the narrative and audiovisual coherence.

Another example application is audiovisual interpolation. In this scenario, the input consists of two segments of an audiovisual clip with a gap in between, and the output is the interpolated content that logically and temporally connects the two segments. For example, the input might be the beginning and ending segments of a scene with a missing middle part, and the output would be the generated content that fills in the gap.

Another example application is audio-to-audio interpolation. In this combination, the input is an audio modality with missing segments, and the output is the interpolated audio. For instance, the input could be a piece of music with certain parts missing due to corruption, and the output would be the restored music with the missing parts filled in.

Another example application is video-to-video interpolation. Here, the input is a video modality with missing segments, and the output is the interpolated video. An example could be a video with gaps due to technical issues, and the output would be the reconstructed video with the missing segments generated to provide a continuous visual narrative.

Although audio and video are provided as example data modalities for the purpose of illustration, the disclosed unified diffusion framework for multimodal data generation can be applied to various combinations of data modalities beyond audio and video. Additional examples of combinations of modalities to which the model can be applied include: text and image; image and depth data; lidar and radar data; genomic and phenotypic data; text and speech; chemical structures and properties; weather data and satellite imagery; electroencephalography (EEG) and functional magnetic resonance imaging (FMRI) data; and/or other modalities of data or combinations thereof.

### Example Diffusion Models for Multivariate Data:

Consider an example of a video diffusion model where the input is a sequence of image frames. In general, this task is modeling multivariate data (e.g., image representations) of d-dimensions with N elements (e.g., number of image frames), henceforth referred to as time-segments. Thus, the multivariate data, x₀=x₀^{1:N}ϵ [symbol] ˜q(x₀) can be represented as a sequence of time-segments, where x₀ⁿϵ [symbol] is the n-th time-segment and d-dimensional representation.

During the forward process of diffusion models, the original data x₀ can be corrupted by gradually injecting noise in a sequence of T timesteps. The noisy data xₜ at time t can be written as xₜ+=xₜ^{1:N}=\sqrt{α̅ₜ}x₀+\sqrt{1−α̅ₜ}εₓ. Here, εₓ=εₓ^{1:N}˜ [symbol] (0, I) can be Gaussian noise injected to the sequence and βₜ can be the noise schedule, αₜ=1−βₜ controls the noise level at each step with \hat{α}ₜ=Πᵢ₌₁^{t}αᵢ. Each noisy time-segment can be represented as xₜⁿ=\sqrt{α̅ₜx₀ⁿ}+\sqrt{1−α̅ₜ}εₓⁿ. During the reverse process, the data is sampled through a chain of reversing the transition kernel q(xₜ₋₁|xₜ) that is estimated by p_{θ}(xₜ₋₁|xₜ)= [symbol] (xₜ₋₁|μ(xₜ,t),σₜ²I), where

$$μ ( {x}_{t} , t ) = \sqrt{{α}_{t}} ( {x}_{t} - \frac{1 - {α}_{t}}{\sqrt{1 - {\overline{α}}_{t}}} {ε}_{θ} ( {x}_{t} , t ) ) .$$

One example training objective is to learn a residual denoiser ε_{θ} at each step as:

$${min}_{θ} {t , {x}_{0} , {ε}_{x}}_{} {‖ {ε}_{θ} ( {x}_{t} , t ) - {ε}_{x} ‖}_{2}^{2} , \qquad ( 1 )$$

where t˜ [symbol] ({1,2, . . . , T}) is the diffusion timestep.

### Example Multimodal Diffusion Models:

Unconditional joint generation (e.g., generating all modalities simultaneously) and conditional generation (e.g., generating one modality conditioned on the rest) are commonly used for multimodal diffusion. Typically, separate models are trained for each task as described below:

### Example Diffusion Models for Joint Generation:

For simplicity, assume two modalities x₀, y₀. The objective in joint generation is to model the joint data distribution, denoted as q(x₀, y₀). To learn this, a joint noise prediction network, denoted as ε_{θ} is defined by rewriting Eq. 1 as follows:

$${min}_{θ} {t , {x}_{0} {y}_{0} , {ε}_{x} , {ε}_{y}}_{} {‖ {ε}_{θ} ( {x}_{t} , {y}_{t} , t ) - [ {ε}_{x} , {ε}_{y} ] ‖}_{2}^{2} , \qquad ( 2 )$$

where (x₀, y₀) is a random data point, [,] denotes concatenation, εₓ, ε_{y}˜ [symbol] (0, I), and t˜ [symbol] ({1, 2, . . . , T}). Diffusion models trained with this objective can perform conditional sampling q(x₀|y₀) using inference-time tricks.

### Example Conditional Training of Diffusion Models:

To learn conditional distributions, expressed as q(x₀|y₀), an example noise prediction network ε_{θ} conditioned on y₀ can be adopted from Eq. 2:

$${min}_{θ} {t , {x}_{0} {y}_{0} , {ε}_{x}}_{} {‖ {ε}_{θ} ( {x}_{t} , {y}_{0} , t ) - {ε}_{x} ‖}_{2}^{2} . \qquad ( 3 )$$

Separate conditional models can be trained for every pair of modalities and input configurations.

### Example Variable Noise Levels Across Modality and Time:

Formally, let M represent the number of modalities with sequence representations (latent spaces or raw data). Without loss of generality, assume the representations in each modality have N time-segments. Further assume they have the same embedding dimension d (which in practice can be achieved by projecting the noisy input from each modality to the desired dimension). The entire sequence can then be simplified as z₀ϵ [symbol] ≡z₀^{(1:M,1:N)}˜q(z₀), where z₀^{(m,n)}ϵ [symbol] denotes the n-th time-segment of m-th modality. For reference, alternative descriptions herein represent two modalities of multivariate data, x₀^{1:N} and y₀^{1:N}, using this notation as z₀^{(1,1:N)} and z₀^{(2,1:N)}, respectively.

Some example implementations can train a single model to support learning arbitrary conditional distributions by using variable noise levels for each modality m and time segment n of the input space z₀. Some example implementations leverage the diffusion timestep vector as t≡t^{(1:M,1:N)}ϵ [symbol] to match the dimensionality of the multimodal inputs, where each element t^{(m,n)}ϵ[1,T] determines the timestep, and in turn the level of noise added to the corresponding element z₀^{(m,n)} of the input z₀.

In a unimodal case, one example goal is to learn the transition kernel q(xₜ₋₁|xₜ) parameterized by p_{θ}(xₜ₋₁|xₜ)= [symbol] (xₜ₋₁|μ(xₜ,t)),σₜ²I). Analogously, by introducing a timestep vector tϵ [symbol] , another example proposed goal is to learn a general transition matrix between the various modalities and time-segments in z₀ at each step:

$${p}_{θ} ( [ {z}_{{t}^{( 1 , 1 )} - 1}^{( 1 , 1 )} , … , {z}_{{t}^{( M , N )} - 1}^{( M , N )} ] \vert [ {z}_{{t}^{( 1 , 1 )}}^{( 1 , 1 )} , … , {z}_{{t}^{( M , N )}}^{( M , N )} ] ) \qquad ( 4 )$$

Then, for diffusion training, some example implementations draw a Gaussian noise sequence ε=ε^{(1:M,1:N)}. Each noise element ε^{(m,n)} is then added to the corresponding element of the original data z₀^{(m.n)} with noise level determined by t^{(m,n)} as follows:

$${z}_{{t}^{( m , n )}}^{( m , n )} = \sqrt{{\overline{α}}_{{t}^{( m , n )}}} {z}_{0}^{( m , n )} + \sqrt{1 - {\overline{α}}_{{t}^{( m , n )}}} {ε}^{( m , n )} \qquad ( 5 )$$

Then, the joint and conditional training objectives in Eq. 2 and 3 can be generalized with a single noise prediction objective to learn the joint distribution ε_{θ} as follows:

$${min}_{θ} {t , {z}_{0 ,} ε}_{} {‖ {ε}_{θ} ( [ {z}_{{t}^{( 1 , 1 )}}^{( 1 , 1 )} , … , {z}_{{t}^{( M , N )}}^{( M , N )} ] , t ) − ε ‖}_{2}^{2} , \qquad ( 6 )$$

where z₀˜q(z₀) is the multimodal input and t is the diffusion timestep vector.

### Example Representative Strategies for Variable Noise Levels:

Using the generalized view of multimodal noise prediction described in Eq. 6, some example implementations implement various strategies for variable noise levels during the forward diffusion. One can imagine an arbitrarily large number of timestep candidates in the vector space of t drawn as functions of time-segments of the multivariate series and modalities. Some example implementations have final diffusion timestep vector for training, t_{ref}ϵ [symbol] where each element t_{ref}^{(i,j)} is sampled from [symbol] ({1,2, . . . , T}),

Vanilla: Same timestep is assigned to all the time-segments and modalities. This is analogous to performing joint learning as t^{(m,n)}=t_{ref}^{(1,1)}, and would be the straightforward way to extend the vanilla distillation approach for the multimodal case.

Per Modality (Pm): Variable timesteps are assigned for each modality, but all time-segments in a given modality have the same timestep as t^{(m,n)}=t_{ref}^{(m,1)}. This is expected to promote cross-modal generation tasks.

Per Time-segment (Pt): Variable timesteps are assigned as t^{(m,n)}=t_{ref}^{(1,n)} by keeping track of the corresponding time-segments across modalities. Intuitively, this should promote better temporal consistency.

Per Time-segment and Per-modality (Ptm): Variable timesteps are assigned for each time-segment and modality as t^{(m,n)}=t_{ref}^{(m,n)}. This would promote better temporal ref correspondence between modalities.

To enable learning a wide range of conditional distributions, some example implementations utilize a training paradigm where a timestep is uniformly randomly selected from the mixture. Specifically, some example implementations of this training paradigm can be referred to as MoNL.

### Example Conditional Inference:

Once the general transition kernel pe is learned in Eq. 4, some example implementations leverage the model's ability to handle arbitrary conditional distributions. Some example implementations achieve this by selectively injecting inputs during inference based on the task specification, e.g., clean (no noise) inputs for conditional portions with t^{(m,n)}=0, and noisy inputs for generating desired portions of the input with the current diffusion step t^{(m,n)}=t.

Consider the case of cross-modal generation, to generate a sequence of M−m_{c} modalities conditioned on m_{c}ϵ(1, M) modalities, some example implementations set timestep elements of M−m_{c} modalities as t and those of m_{c} conditioning modalities as 0, which achieves:

$${p}_{θ} ( {z}_{t - 1}^{( {m}_{c} + 1 : M , 1 : N )} \vert {z}_{t}^{( {m}_{c} + 1 : M , 1 : N )} , {z}_{0}^{( 1 : {m}_{c} , 1 : N )} ) \qquad ( 7 )$$

Similarly, for multimodal interpolation, to generate N−n_{c} time-segments of all modalities jointly, conditioned on n_{c}ϵ(1, N) time-segments, some example implementations set the timestep for the N−n_{c} time-segments as t, and for the conditioning n, time-segments as 0, which achieves p_{θ}(zₜ₋₁^{(1:M,n}^{_{c}}^{+1:N)}|zₜ^{(1:M,n}^{_{c}}^{+1:N),z}₀^{(1:M,1:n}^{_{c}}⁾). Unconditional joint generation is also possible by setting each timestep as the same t, to estimate the transition kernel, p_{θ}(zₜ₋₁^{(1:M,1:N)}|zₜ^{(1:M,1:N)}). Intuitively, the example proposed mixture of noise levels is analogous to self-supervised learning which bypasses the need for predefined tasks during training but enables a deeper understanding of multimodal temporal relationships.

### Example Audiovisual Latent Diffusion Transformer (AVDiT):

An example proposed model can include the following components: (1) latent space representations from audio and video autoencoders, and (2) an Audiovisual diffusion transformer (AVDiT) for joint noise prediction.

### Example Latent Space Representations:

For a video of 1+Lᵥ frames, represented as vϵ [symbol] , some example implementations use MAGVIT-v2, a causal autoencoder to achieve efficient spatial and temporal compression. MAGVIT-v2 results in a low-dimensional representation, x₀ϵ [symbol] , by a compression factor of

$${r}_{s} = \frac{H}{h} = \frac{W}{w}$$

in space and

$${r}_{{t}_{v}} = \frac{{L}_{v}}{{l}_{v}}$$

in time. The use of causal 3D convolutions ensures that the embedding for a given frame is solely influenced by preceding frames, preventing flickering artifacts common in frame-level autoencoders.

For audio with Lₐ frames, aϵ [symbol] , some example implementations use SoundStream, a state-of-the-art neural audio autoencoder. Some example implementations use the latents y₀ϵ [symbol] prior to quantization as audio latents, a compression rate of

$${r}_{{t}_{a}} = \frac{{L}_{a}}{{l}_{a}}$$

in time. The time-segments in the proposed formulation refer to the 1+lᵥ and lₐ temporal dimensions in the video and audio latent spaces respectively.

### Example Audiovisual Transformer for Joint Noise Prediction:

Transformers are a natural fit for multimodal generation as they can: (1) efficiently integrate multiple modalities and their interactions, (2) capture intricate spatiotemporal dependencies, and (3) have shown impressive video generation capabilities. Inspired by these benefits, some example implementations introduce AVDiT, a noise prediction network for latent diffusion. The Transformer first processes the timestep embeddings and positional encodings to create an embedding of the timestep vector. This embedding serves as a conditioning signal and is utilized to dynamically calculate the scaling and shifting parameters for AdaLN during the Transformer Layer Normalization step. This enables the normalization to incorporate the conditioning information of variable noise levels. Some example implementations first implement the lₐ and 1+lᵥ time-dimensions for audio and video embeddings respectively. When applying MoNL, some example implementations can easily keep track of the corresponding time segments among the lₐ and 1+lᵥ dimensions, given the temporal compression factors in each modality. The noisy latents are then linearly projected matching the final dimension d by adding appropriate spatiotemporal positional embeddings for video and temporal positional embeddings for audio, resulting in d dimensional embeddings for each modality which are then concatenated.

### Example Visualizations:

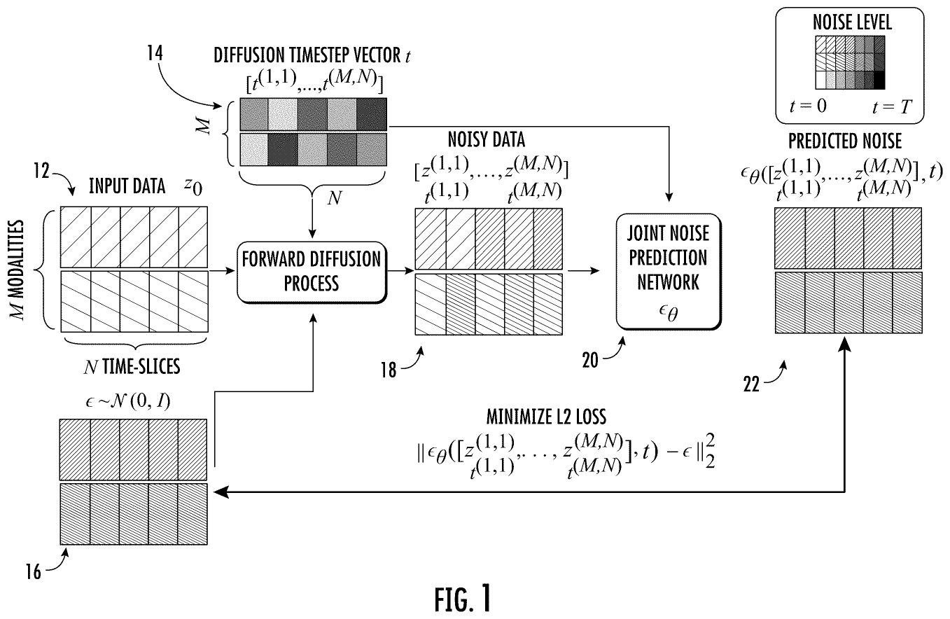

Referring now to FIG. 1, a graphical diagram is provided illustrating an example training framework designed in accordance with embodiments of the present disclosure. The training framework is configured to train a denoising diffusion model 20 on multi-modal data, which includes input data 12 comprising a plurality of input data elements. These input data elements correspond to at least two different data modalities and at least two different time-slices, as indicated by the M modalities and N time-slices labels in FIG. 1.

One aspect of the framework is the diffusion timestep vector 14, which comprises a plurality of timestep values for the input data elements. The timestep vector 14 allows for the application of variable timesteps across the temporal dimension and modalities of the input data 12. The diffusion timestep vector 14 is depicted as an array with elements t_{1,1}, . . . , t_{M,N}, where each element corresponds to a specific modality and time-slice of the input data 12.

The forward diffusion process, as part of the training framework, includes adding a respective set of noise 16 to each of the input data elements to generate a plurality of noised data elements 18. This process is guided by the diffusion timestep vector 14, where the perturbation level of the noise added to each input data element is controlled by the corresponding timestep value. The noise is represented by ¿, and can, for example, be drawn from a Gaussian distribution N(0, I), and added to the input data 12 to produce the noised data elements 18.

Subsequently, the noised data elements 18 are processed by the denoising diffusion model 20 to predict the noise elements 22. The denoising diffusion model 20 can be a joint noise prediction network that generates predicted noise elements 22 for the noised data elements 18. The predicted noise elements 22 are then compared against the actual noise added to the input data elements using a loss function, e.g., depicted by the minimize L2 loss block in FIG. 1. This loss function is used to modify the values of the parameters of the denoising diffusion model 20, enhancing its ability to accurately predict and remove noise from the input data elements.

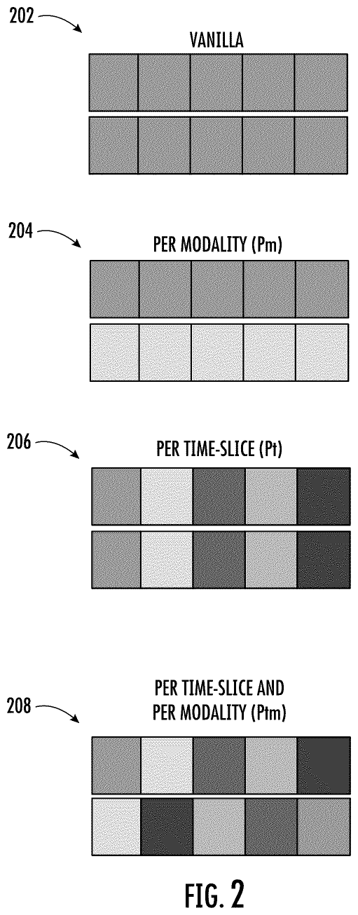

The training framework depicted in FIG. 1 can be adapted to various types of timestep vectors, examples of which are described with respect to FIG. 2. Each of these timestep vectors can be selected or randomly sampled to introduce variable perturbation levels during the diffusion training. This innovative approach to parameterizing the diffusion timestep in the forward diffusion process enables the model to learn a broad range of conditional distributions in multi-modal data using a single model. It provides a versatile solution for a variety of cross-modal and multi-modal interpolation tasks, ensuring that the generated samples are temporally and perceptually consistent with the conditioning input.

Referring now to FIG. 2, graphical depictions are provided illustrating example timestep strategies or types according to example embodiments of the present disclosure. These timestep strategies can be used when training the denoising diffusion model 20 by determining the perturbation level of noise added to the input data elements during the forward diffusion process.

The first depicted timestep strategy is the vanilla timestep vector 202, which assigns the same timestep value to all time-slices and modalities. This uniform approach is analogous to a joint learning process where the perturbation levels are consistent across the entire input data 12, regardless of the specific characteristics of each modality or temporal segment.

The second strategy is the per-modality timestep vector 204, which assigns variable timesteps to each modality, but maintains consistency across all time-slices within a given modality. This strategy promotes enhanced cross-modal generation tasks by allowing for modality-specific perturbation levels that can be tailored to the unique properties of each data modality.

The third strategy, the per-time-slice timestep vector 206, introduces variable timesteps across different time-slices while keeping the timestep value consistent for all modalities within each time-slice. This approach can improve temporal consistency in sequence generation tasks, ensuring that the perturbation levels are adapted to the temporal dynamics of the input data 12.

Finally, the most granular timestep strategy is the per-time-slice per-modality timestep vector 208, which provides a unique timestep value for each combination of modality and time-slice. This fine-grained control allows for the most precise adaptation of perturbation levels. This is particularly advantageous for tasks including multimodal-sequence and cross-modal generation, where the correspondence between modalities over time is important.

Each of these timestep strategies can be applied during the training of the denoising diffusion model 20 to introduce variable perturbation levels, as indicated by the varying shades in the depictions. This variability enables the model to learn a broad range of conditional distributions, supporting the generation of multi-modal data that is temporally and perceptually consistent with the conditioning input. The choice of timestep strategy can be determined based on the specific requirements of the task at hand, with the possibility of random sampling during training to ensure a robust and versatile learning process.

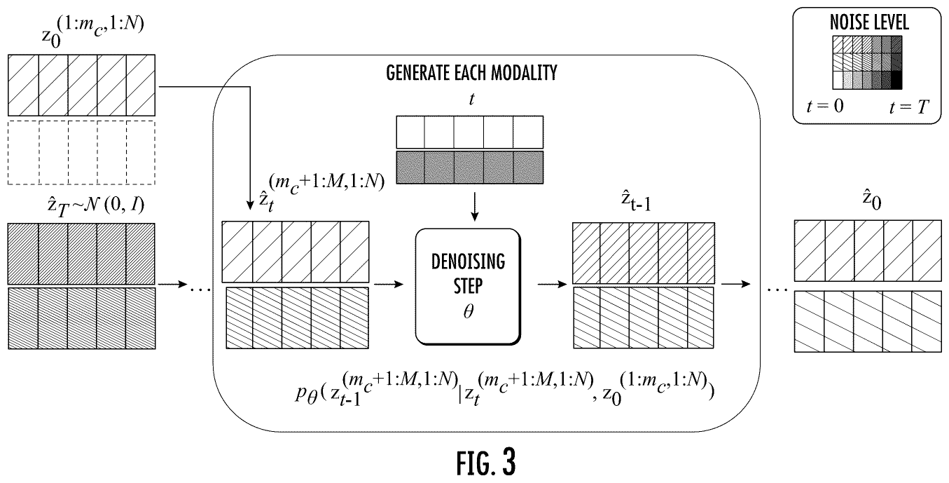

Referring now to FIG. 3, a graphical diagram is provided illustrating an example application of cross-modal generation in accordance with example embodiments of the present disclosure. The process begins with obtaining input data comprising a plurality of input data elements. In this example, the input data elements are depicted as a matrix z₀. In particular, in the example shown in FIG. 3, data elements are provided for multiple time-slices of a first modality (upper), while no or null data elements are provided for a second modality (lower).

The diagram illustrates a timestep vector that includes first timestep values (e.g., which may be zero) for the first modality (upper) and second timestep values (e.g., which may be non-zero) for the second modality (lower). This timestep vector comprises a plurality of timestep values, represented as a sequence of shaded boxes, each corresponding to a respective input data element. The varying shades indicate the progression of noise levels from no noise at t=0 to maximum noise at t=T, as per the noise level legend.

A respective set of noise, e.g., drawn from a Gaussian distribution N(0, I), is added to each input data element to generate noised data elements, depicted as darker shaded boxes. The perturbation level of the noise is controlled by the corresponding timestep value in the timestep vector. The noised data elements are then processed by the denoising diffusion model, indicated by the denoising step θ, which predicts the noise elements that when removed will result in clean outputs. Thus, this prediction process aims to reverse the noise addition to reconstruct the original input data elements for the provided modality and to generate new data for unprovided modality.

The cross-modal generation is visualized through the transformation of the noised data elements, via the denoising diffusion model, into a new set of data elements \hat{z}ₜ₋₁ that are one timestep closer to the clean data. The denoising diffusion model utilizes a transition kernel to facilitate this process, ultimately leading to the generation of a clean set of data elements \hat{z}₀ that are consistent with the input condition.

The disclosed approach allows for the generation of each modality by selectively applying the timestep vector to control the noise levels for the desired modality. This enables the generation of multi-modal data that is temporally and perceptually consistent with the conditioning input, as demonstrated by the final output \hat{z}₀.

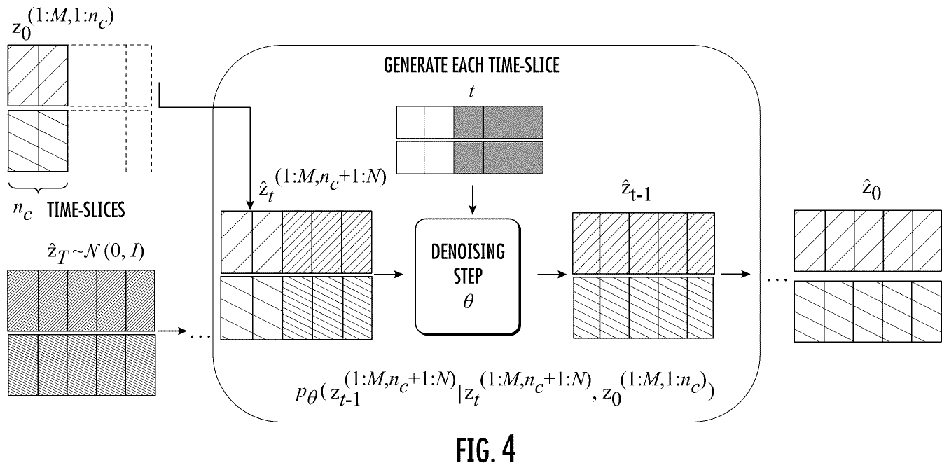

Referring now to FIG. 4, a graphical diagram is provided to illustrate an example application of multi-modal completion in accordance with embodiments of the present disclosure. In this application, the denoising diffusion model can generate multi-modal data conditioned on a subset of input data elements, effectively performing data completion tasks. The subset of input data elements corresponds to a segment of the input data comprising n_{c} time-slices, where n_{c}<N, and includes all modalities M. This subset serves as the conditioning data upon which the subsequent data generation is based.

FIG. 4 depicts the process of generating each time-slice t, where the denoising diffusion model applies a denoising step θ to a set of noised data elements that includes both the conditioning data and a set of noise, represented as \hat{z}ₜ˜N(0, I), added to the remaining time-slices. The noise can be sampled from a Gaussian distribution, ensuring that the noised data elements for the non-conditioned time-slices are perturbed appropriately for the current timestep t specified by the timestep vector. For example, the timestep vector may provide first timestep values (e.g., which may be zero) for the time-slices included in the input conditioning data and may provide second timestep values (e.g., which may be non-zero) for the time-slices that are not included in the input conditioning data.

The denoising diffusion model can employ a transition kernel to process the noised data elements and predict the noise elements for the non-conditioned time-slices. This results in a new set of data elements zₜ₋₁ that are one timestep closer to the clean data, moving iteratively towards the final clean set of data elements \hat{z}₀. The transition kernel can operate on the noised data elements according to the conditional distributions learned during the training process, as described by the present disclosure.

The multi-modal completion task illustrated in FIG. 4 demonstrates the capability of the denoising diffusion model to handle arbitrary conditional distributions, where the conditioning input can be a time-segment or an entire modality or a combination thereof. This flexibility allows for the generation of multi-modal data that is consistent with the input condition, showcasing the versatility of the task-agnostic diffusion framework proposed by the present disclosure.

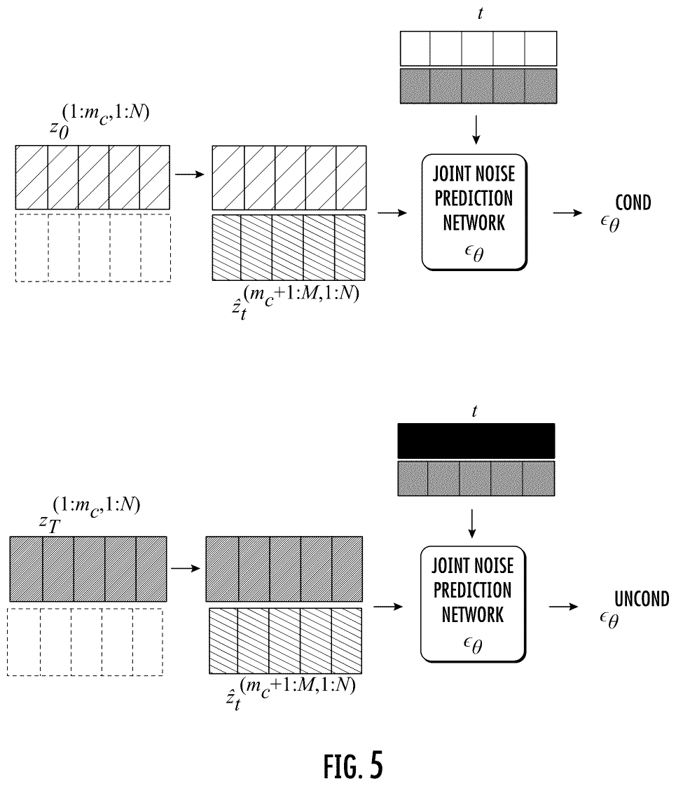

Referring now to FIG. 5, a graphical diagram is provided to illustrate an example multi-modal classifier-free guidance approach in accordance with embodiments of the present disclosure. The approach utilizes a joint noise prediction network, which processes input data elements to generate predicted noise elements. Specifically, FIG. 5 illustrates application of CFG for free in the proposed MoDT approach for cross-modal generation tasks. Whereas a null token is used in traditional CFG for unconditional output, formulating diffusion timestep as a vector enables this by setting the input condition per task-specification to pure noise. The diagram depicts two parallel processes, one for conditional generation and one for unconditional generation, to demonstrate the classifier-free guidance technique.

In the conditional generation process shown in the top half of FIG. 5, the input data elements are processed in the presence of a timestep vector. The timestep vector, comprising a plurality of timestep values, controls the perturbation level of noise during the forward diffusion process. In particular, in the conditional generation process, the timestep vector may provide a first timestep value (e.g., which may be zero) for the provided conditioning data.

The joint noise prediction network receives the noised data elements and a subset of the timestep vector corresponding to the conditional generation. The network then predicts the noise elements, denoted as ε_{cond}, which are the estimated noise values that need to be removed to reconstruct the original data elements or synthesize the new data elements.

In the unconditional generation process shown in the bottom half of FIG. 5, the joint noise prediction network operates without the constraints of the conditional input data. For example, for the input data elements for which conditioning data was present in the conditional process, in the unconditional generation process the timestep vector may instead provide a second value (e.g., which may be a non-zero value such as a full noising value T). Stated differently, while in the conditional generation process the conditioning data was not noised or only noised to a lesser extent, in the unconditional generation process the conditioning data may be noised to a greater extent (e.g., fully noised). The network predicts the noise elements, denoted as ε_{uncond}, which represent the noise values for the unconditional generation.

The classifier-free guidance approach is depicted by the two outcomes, ε_{cond} and ε_{uncond}, which are the predicted noise elements for the conditional and unconditional processes, respectively. These two noise predictions can be linearly combined to arrive at a classifier-free noise prediction. This approach enhances the quality of the generated samples by blending the outputs of both the conditional and unconditional generations, leveraging the strengths of each to produce high-fidelity multi-modal data.

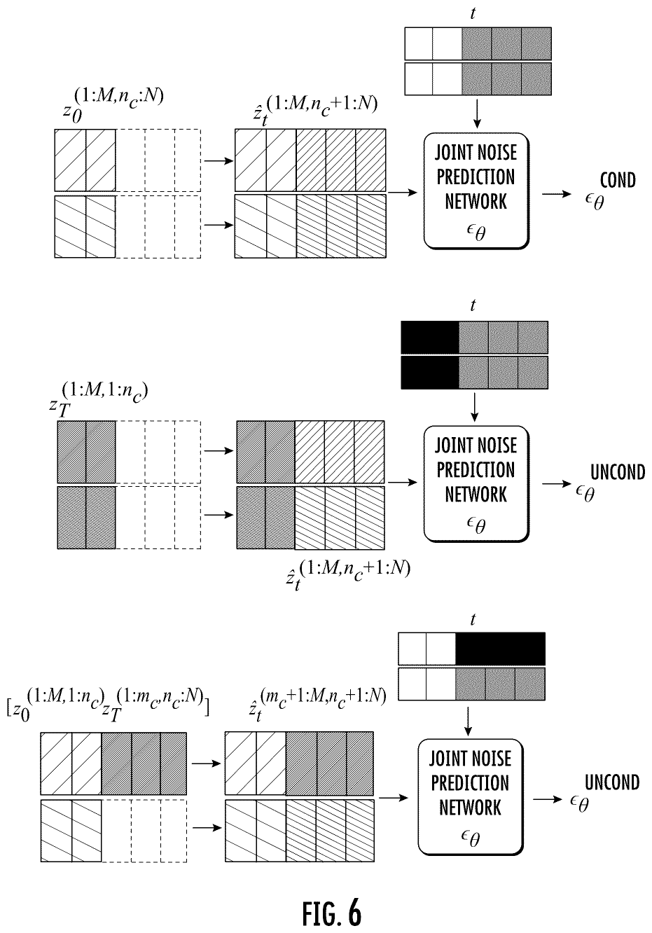

FIG. 6 provides a graphical diagram to illustrate another example multi-modal classifier-free guidance approach in accordance with embodiments of the present disclosure. In particular, FIG. 6 illustrates application of CFG for free in the proposed MoDT approach for multimodal interpolation tasks. Because the vector formulation of the timestep enables applying variable noise levels to different portions of the input one can construct a different CFG with “mix-and-match” of modalities and time-segments for creating unconditional outputs. FIG. 6 shows an example for multimodal interpolation task for (top) conditional output with two variations, (middle) unconditional output with respect to input condition per task specification, and (bottom) partial conditional output, but unconditional output with respect to modalities

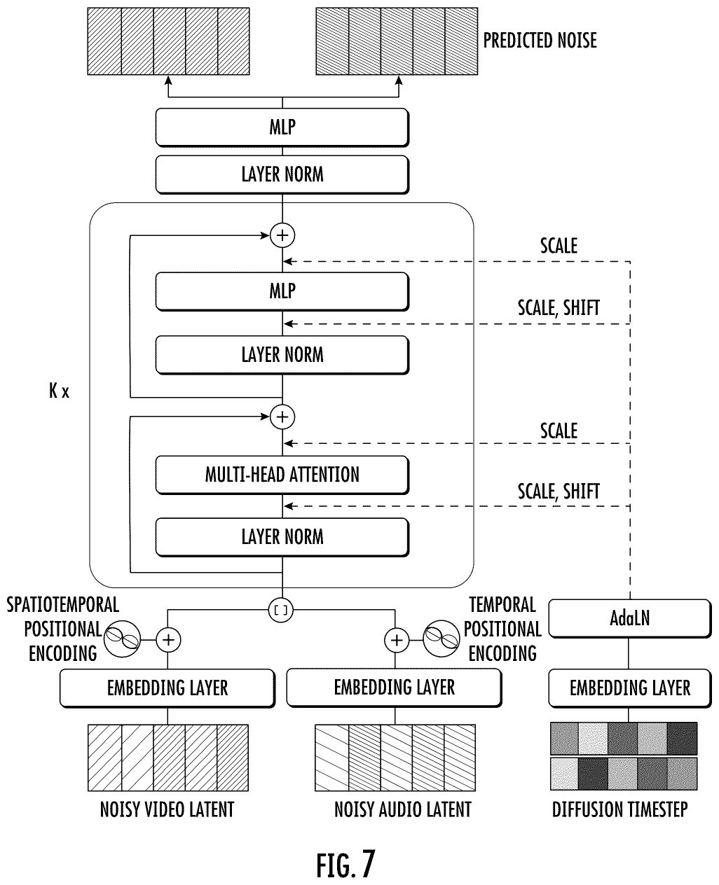

Referring now to FIG. 7, a graphical diagram is provided illustrating an example AV-Transformer model configured in accordance with embodiments of the present disclosure. The AV-Transformer model serves as a noise prediction network for latent diffusion, capable of processing noisy latent representations from multiple modalities and predicting the noise to be removed for data denoising.

The model can include an embedding layer for each modality, which receives noisy video latent and noisy audio latent inputs. These inputs are latent space representations derived from the input data elements, which correspond to visual and auditory modalities, respectively. The embedding layers transform the noisy latent inputs into a suitable format for subsequent processing by the transformer network.

To account for the temporal dynamics and multimodal nature of the input data, spatiotemporal positional encoding and temporal positional encoding can be applied to the noisy video latent and noisy audio latent, respectively. These encodings augment the latent representations with information about their position within the sequence, allowing the model to maintain temporal coherence during the denoising process.

The core of the AV-Transformer model is a series of transformer layers that apply multi-head attention mechanisms to the encoded inputs. These layers operate iteratively, indicated by the K×notation, to capture the complex interactions and dependencies between the different modalities and their temporal evolution. Each transformer layer can include a multi-head attention block followed by a layer normalization step, which standardizes the inputs to stabilize the learning process.

Further enhancing the model's ability to adapt to variable diffusion timesteps, adaptive layer normalization (AdaLN) can be is incorporated. This component dynamically scales and shifts the inputs and outputs of the transformer layers based on the diffusion timestep embedding. The diffusion timestep embedding represents the timestep vector, which controls the perturbation level of noise added to the input data elements during the forward diffusion process.

Upon processing the noisy latents through the transformer layers, the AV-Transformer model generates predicted noise. This predicted noise represents the estimated noise components that must be removed from the noised data elements to reconstruct the clean input data.

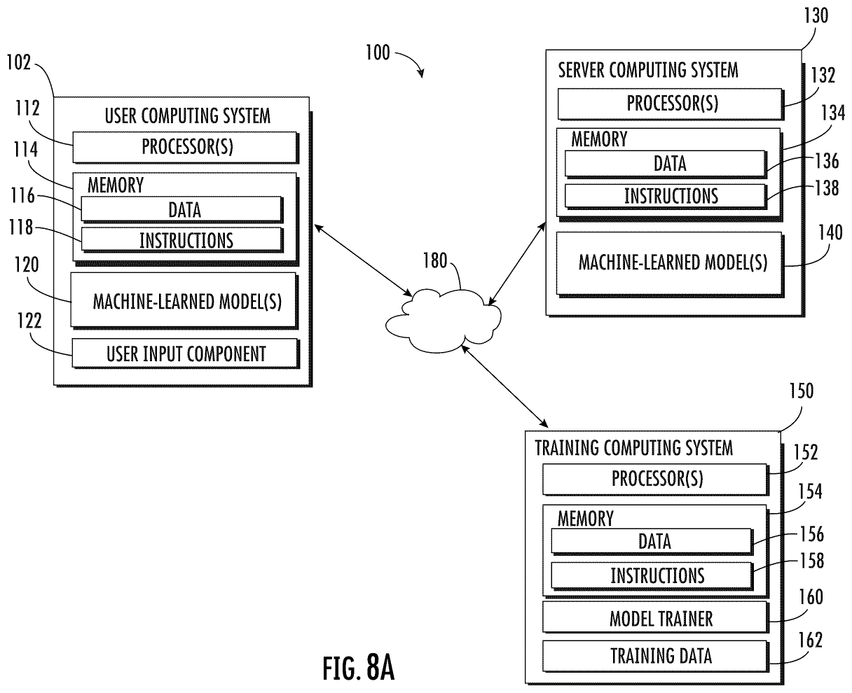

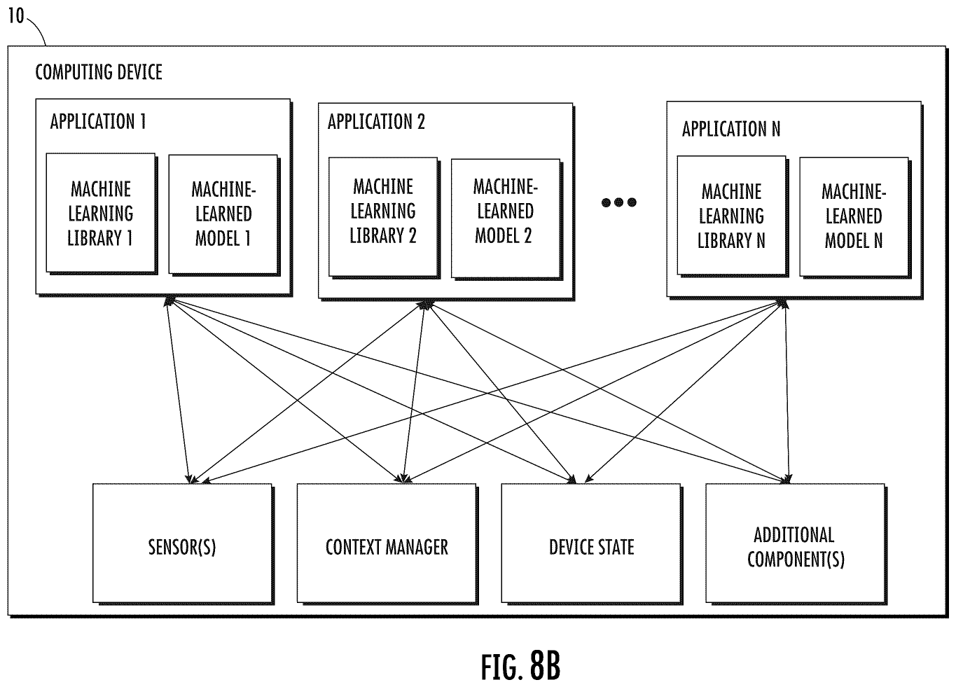

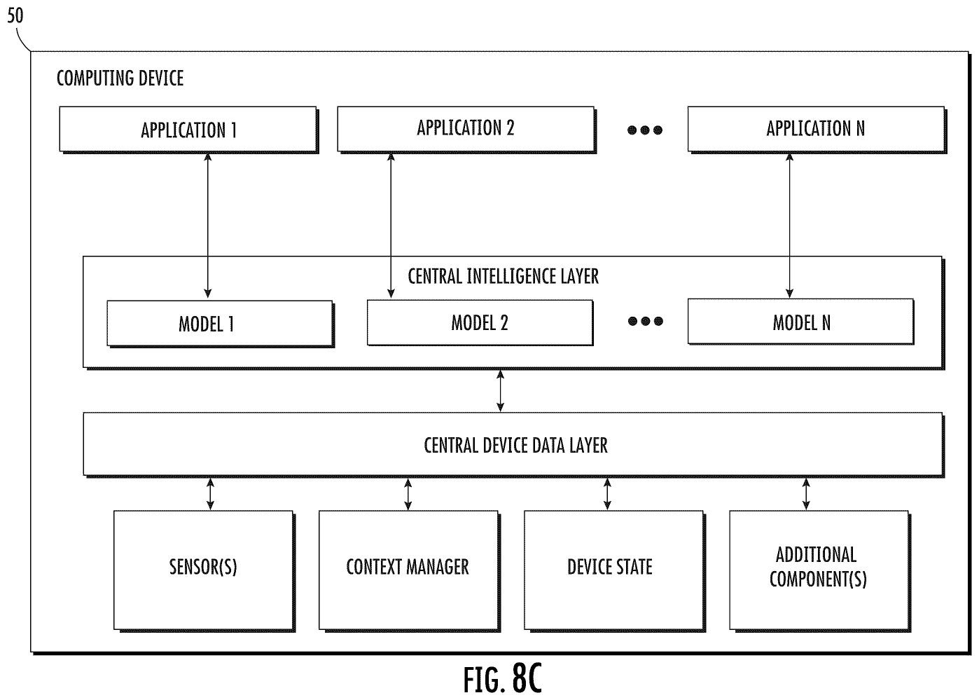

FIG. 8A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-6.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel denoising or content generation across multiple instances of inputs).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service (e.g., a denoising or content generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-6.

One example type of machine learning model (e.g., model 120 and/or 140) is a denoising diffusion model (or “diffusion model”). A denoising diffusion model can be defined as a type of generative model that learns to progressively remove noise from a set of input data to generate new data samples. A comprehensive discussion of diffusion models is provided by Yang L., Zhang Z., Song Y., Hong S., Xu R., Zhao Y., Zhang W., Cui B., and Yang M., Diffusion Models: A Comprehensive Survey of Methods and Applications, arXiv: 2209.00796 [cs.LG]. See also, Sohl-Dickstein, J., Weiss, E., Maheswaranathan, N., & Ganguli, S. (2015). Deep Unsupervised Learning using Nonequilibrium Thermodynamics. In International Conference on Machine Learning (ICML); Song, Y., & Ermon, S. (2019). Generative Modeling by Estimating Gradients of the Data Distribution. In Advances in Neural Information Processing Systems (NeurIPS); Ho, J., Jain, A., & Abbeel, P. (2020). Denoising Diffusion Probabilistic Models. In Advances in Neural Information Processing Systems (NeurIPS); and Song, Y., Sohl-Dickstein, J., Kingma, D. P., Kumar, A., Ermon, S., & Poole, B. (2020). Score-Based Generative Modeling through Stochastic Differential Equations. In International Conference on Learning Representations (ICLR).

More particularly, in some implementations, the diffusion process of a denoising diffusion model can include both forward and reverse diffusion phases. The forward diffusion phase can include gradually adding noise (e.g., Gaussian noise) to data over a series of time steps. This transformation can lead to the data eventually resembling pure noise. For example, in the context of image processing, an initially clear image can incrementally receive noise until it is indistinguishable from random noise. In some implementations, this step-by-step addition of noise can be parameterized by a variance schedule that controls the noise level at each step.

Conversely, the reverse diffusion phase can include systematically removing the noise added during the forward diffusion to reconstruct the original data sample or to generate new data samples. This phase can use a trained neural network model to predict the noise that was added (or conversely, that should be removed) at each step and subtract it from the noisy data. For instance, starting from a purely noisy image, the model can iteratively denoise the image, progressively restoring details until a clear image is obtained.

This process of reverse diffusion can be guided by learning from a set of training data, where the model learns the optimal way to remove noise and recover data. The ability to reverse the noise addition effectively allows the generation of new data samples that are similar to the training data and/or modified according to specified conditions. In particular, in the learned reverse diffusion process, the diffusion model can be used to generate new samples that can either replicate the original or produce variations based on the learned data distribution.

In some implementations, denoising diffusion models can operate in either pixel space or latent space, each offering distinct advantages depending on the application requirements. Operating in pixel space means that the model directly manipulates and generates data in its original form, such as raw pixel values for images. For example, when generating images, the diffusion process can add or remove noise directly at the pixel level, allowing the model to learn and reproduce fine-grained details that are visible in the pixel data.

Alternatively, operating in latent space can include transforming the data into a compressed, abstract representation before applying the diffusion process. This can be beneficial for handling high-dimensional data or for improving the computational efficiency of the model. For instance, an image can be encoded into a lower-dimensional latent representation using an encoder network, and the diffusion process can then be applied in this latent space. The denoised latent representation can subsequently be decoded back into pixel space to produce the final output image. This approach can reduce the computational load during the training and sampling phases and can sometimes help in capturing higher-level abstract features of the data that are not immediately apparent in the pixel space.

In some implementations, denoising diffusion models can utilize probability distributions to manage the transformation of data throughout the diffusion process. As one example, Gaussian distributions can be employed in the forward diffusion phase, where noise added to the data is typically modeled as Gaussian. This method can be beneficial for applications like image processing or audio synthesis, where the gradual addition of Gaussian noise helps in creating a smooth transition from original data to a noise-dominated state. However, the model can also be designed to use other types of noise distributions as part of its stochastic process.

In the reverse phase, learned transition distributions can guide the denoising steps. Specifically, a parameterized model (e.g., neural network) can be used to predict the noise to be removed at each step of the reverse phase.

Model parameters can refer to parameter values within the denoising diffusion model that can be learned from training data to optimize the performance of the denoising diffusion model. These parameters can include weights of the neural networks used to predict noise in the reverse diffusion process, as well as parameters defining the noise schedule in the forward process.

The architecture of an example denoising diffusion model can include one or more neural networks. The neural networks can be trained to parameterize the transition kernels in the reverse Markov chain. As examples, the architecture of a denoising diffusion model can incorporate various types of neural networks, such as Convolutional Neural Networks (CNNs) or Recurrent Neural Networks (RNNs).

As a specific example, in some implementations, the neural network architecture can take the form of a U-Net. The U-Net architecture is characterized by its U-shaped structure, which includes a contracting path and an expansive path. The contracting path follows the typical architecture of a convolutional network, including repeated application of convolutions, followed by pooling operations that reduce the spatial dimensions of the feature maps. The expansive path of the U-Net, on the other hand, can include a series of up-convolutions and concatenations with high-resolution features from the contracting path. This can be achieved through skip connections that directly connect corresponding layers in the contracting path to layers in the expansive path.

More generally, the neural network architecture in denoising diffusion models can include multiple layers that can include various types of activation functions. These functions introduce non-linearities that enable the network to capture and learn complex data patterns effectively, although the specific choices of layers and activations can vary based on the model design and application requirements.

Additionally, the architecture can include special components like residual blocks and attention mechanisms, which can enhance the model's performance. Residual blocks can help in training deeper networks by allowing gradients to flow through the network more effectively. Attention mechanisms can provide a means for the model to focus on specific parts of the input data, which is advantageous for applications such as language translation or detailed image synthesis, where contextual understanding significantly impacts the quality of the output. These components are configurable and can be integrated into the neural network architecture to address specific challenges posed by the complexity of the data and the requirements of the generative task.

In some implementations, the training process of a denoising diffusion model can be oriented towards specific learning objectives. These objectives can include minimizing the difference between the original data and the data reconstructed after the reverse diffusion process. Specifically, in some implementations, an objective can include minimizing the Kullback-Leibler divergence between the joint distributions of the forward and reverse Markov chains to ensure that the reverse process effectively reconstructs or generates data that closely matches the training data. As another example, in image processing applications, the objective may be to minimize the pixel-wise mean squared error between the original and reconstructed images. Additionally, the model can be trained to optimize the likelihood of the data given the model, which can enhance the model's ability to generate new samples that are indistinguishable from real data.

Various strategies can be used to perform the training process for diffusion models. Gradient descent algorithms, such as stochastic gradient descent (SGD) or Adam, can be utilized to update the model's parameters. Moreover, learning rate schedules can be implemented to adjust the learning rate during training, which can help in stabilizing the training process and improving convergence. For instance, a learning rate that decreases gradually as training progresses can lead to more stable and reliable model performance.

Various loss functions can be used guide the training of denoising diffusion models. Example loss functions include the mean squared error (MSE) for regression tasks or cross-entropy loss for classification tasks within the model. Additionally, variational lower bounds, such as the evidence lower bound (ELBO), can be used to train the model under a variational inference framework. These loss functions can help in quantifying the discrepancy between the generated samples and the real data, guiding the model to produce outputs that closely resemble the target distribution.

In some implementations, temperature sampling in denoising diffusion models can be used to control the randomness of the generation process. By adjusting the temperature parameter, one can modify the variance of the noise used in the sampling steps, which can affect the sharpness and diversity of the generated outputs. For instance, a lower temperature can result in less noisy and more precise samples, whereas a higher temperature can increase sample diversity but may also introduce more noise and reduce sample quality.

In some implementations, conditional generation can allow the generation of data samples based on specific conditions or attributes. Conditional generation in denoising diffusion models can include modifying the reverse diffusion process based on additional inputs (e.g., conditioning inputs) such as class labels or text descriptions, which guide the model to generate data samples that are more likely to meet specific conditions. This can be implemented by conditioning the model on additional inputs such as class labels, text descriptions, or other data modalities. For example, in a model trained on a dataset of images and their corresponding captions, the model can generate images that correspond to a given textual description, enabling targeted image synthesis.

More particularly, denoising diffusion models can be conditioned using various types of data to guide the generation process towards specific outcomes. One common type of conditioning data is text. For example, in generating images from descriptions, the model can use textual inputs like “a sunny beach” or “a snowy mountain” to generate corresponding images. The text can be processed using natural language processing techniques to transform it into a format that the model can utilize effectively during the generation process.

For example, one type of conditioning data can include text embeddings. Text embeddings are vector representations of text that capture semantic meanings, which can be derived from pre-trained language models such as BERT or CLIP. These embeddings can provide a denser and potentially more informative representation of text than raw text inputs. For instance, in a diffusion model tasked with generating music based on mood descriptions, embeddings of words like “joyful” or “melancholic” can guide the audio generation process to produce music that reflects these moods.

Additionally, conditioning can also include using categorical labels or tags. This approach can be particularly useful in scenarios where the data needs to conform to specific categories or classes.

Classifier-free guidance is a technique that can enhance the control over the sample generation process without the need for an additional classifier model. This can be achieved by modifying the guidance scale during the reverse diffusion process, which adjusts the influence of the learned conditional model. For instance, by increasing the guidance scale, the model can produce samples that more closely align with the specified conditions, improving the fidelity of generated samples that meet desired criteria without the computational overhead of training and integrating a separate classifier.

In some implementations, denoising diffusion models can integrate with other generative models to form hybrid models. For instance, combining a denoising diffusion model with a Generative Adversarial Network (GAN) can leverage the strengths of both models, where the diffusion model can ensure diversity and coverage of the data distribution, and the GAN can refine the sharpness and realism of the generated samples. Another example can include integration with Variational Autoencoders (VAEs) to improve the latent space representation and stability of the generation process.

Efficiency improvements are beneficial aspects of denoising diffusion models. One way to achieve this is by reducing the number of diffusion steps required to generate high-quality samples. For example, sophisticated training techniques such as curriculum learning can be employed to gradually train the model on easier tasks (fewer diffusion steps) and increase complexity (more steps) as the model's performance improves. Additionally, architectural optimizations such as implementing more efficient neural network layers or utilizing advanced activation functions can decrease computational load and improve processing speed during both training and generation phases.

Noise scheduling strategies can improve the performance of denoising diffusion models. By carefully designing the noise schedule—the variance of noise added at each diffusion step—models can achieve faster convergence and improved sample quality. For example, using a learned noise schedule, where the model itself optimizes the noise levels during training based on the data, can result in more efficient training and potentially better generation quality compared to fixed, predetermined noise schedules.

In some implementations, learned upsampling in denoising diffusion models can facilitate the generation of high-resolution outputs from lower-resolution inputs. This technique can be particularly useful in applications such as high-definition image generation or detailed audio synthesis. Learned upsampling can include additional model components that are trained to increase the resolution of generated samples through the reverse diffusion process, effectively enhancing the detail and quality of outputs without the need for externally provided high-resolution training data. In some cases, these additional learned components can be referred to as “super-resolution” models.

In some implementations, denoising diffusion models can be applied to the field of image synthesis, where they can generate high-quality, photorealistic images from a distribution of training data. For example, example models can be used to create new images of landscapes, animals, or even fictional characters by learning from a dataset composed of similar images. The model can add noise to these images and then learn to reverse this process, effectively enabling the generation of new, unique images that maintain the characteristics of the original dataset.

Denoising diffusion models can also be utilized in audio generation. They can generate clear and coherent audio clips from noisy initial data or even from scratch. For instance, in the music industry, example models can help in creating new musical compositions by learning from various genres and styles. Similarly, in speech synthesis, denoising diffusion models can generate human-like speech from text inputs, which can be particularly beneficial for virtual assistants and other AI-driven communication tools.

Other potential use cases of denoising diffusion models extend across various fields including drug discovery, where example models can help in generating molecular structures that could lead to new pharmaceuticals. Additionally, in the field of autonomous vehicles, denoising diffusion models can be used to enhance the processing of sensor data, improving the vehicle's ability to interpret and react to its environment.

In some implementations, the performance of denoising diffusion models can be evaluated using various metrics that assess the quality and diversity of generated samples. The Inception Score (IS) is one such metric that can be used; it measures how distinguishable the generated classes are and the confidence of the classification. For example, a higher Inception Score indicates that the generated images are both diverse across classes and each image is distinctly recognized by a classifier as belonging to a specific class. Another commonly used metric is the Fréchet Inception Distance (FID), which assesses the similarity between the distribution of generated samples and real samples, based on features extracted by an Inception network. A lower FID indicates that the generated samples are more similar to the real samples, suggesting higher quality of the generated data.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, combinations of data across multiple data modalities.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 8A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 8B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 8B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 8C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 8C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 8C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to train a denoising diffusion model on multi-modal data, the method comprising:
obtaining, by a computing system comprising one or more computing devices, input data comprising a plurality of input data elements, wherein the plurality of input data elements correspond to at least two different data modalities and at least two different time-slices;
determining, by the computing system, a timestep vector comprising a plurality of timestep values respectively for the plurality of input data elements, wherein the plurality of timestep values comprise at least two different values;
adding, by the computing system, a respective set of noise to each of the plurality of input data elements to generate a plurality of noised data elements, wherein a perturbation level of the respective set of noise that is added to each input data element to generate the corresponding noised data element is controlled by the timestep value provided for such input data element by the timestep vector;
processing, by the computing system, the plurality of noised data elements with the denoising diffusion model to generate a plurality of predicted noise elements respectively for the plurality of noised data elements; and
modifying, by the computing system, one or more values of one or more parameters of the denoising diffusion model based on a loss function that compares the plurality of predicted noise elements with the sets of noise that were added to the plurality of input data elements.

2. The computer-implemented method of claim 1, wherein the timestep vector comprises a per-modality timestep vector that provides a different timestep value for each of the at least two different data modalities, and wherein the timestep value for each data modality is consistent across the at least two different time-slices.

3. The computer-implemented method of claim 1, wherein the timestep vector comprises a per-time-slice timestep vector that provides a different timestep value for each of the at least two different time-slices, and wherein the timestep value for each time-slice is consistent across the at least two different data modalities.

4. The computer-implemented method of claim 1, wherein the timestep vector comprises a per-time-slice and per-modality timestep vector that provides a different timestep value for each of the plurality of input data elements.

5. The computer-implemented method of claim 4, wherein determining the timestep vector comprises randomly sampling the plurality of timestep values.

6. The computer-implemented method of claim 1, wherein determining the timestep vector comprises randomly selecting a timestep vector type from a group including: a per-modality timestep vector, a per-time-slice timestep vector, and a per-time-slice and per-modality timestep vector.

7. The computer-implemented method of claim 1, wherein the at least two different data modalities comprise an audio modality and a vision modality.

8. The computer-implemented method of claim 1, wherein the plurality of input data elements comprise a plurality of latent space representations.

9. The computer-implemented method of claim 8, wherein the plurality of latent space representations were generated using pre-trained modality-specific encoder models.

10. The computer-implemented method of claim 1, wherein the loss function comprises an L2 loss.

11. A computing system comprising a denoising diffusion model that has been trained by the performance of training operations, the training operations comprising:
obtaining, by a computing system comprising one or more computing devices, input data comprising a plurality of input data elements, wherein the plurality of input data elements correspond to at least two different data modalities and at least two different time-slices;
determining, by the computing system, a timestep vector comprising a plurality of timestep values respectively for the plurality of input data elements, wherein the plurality of timestep values comprise at least two different values;
adding, by the computing system, a respective set of noise to each of the plurality of input data elements to generate a plurality of noised data elements, wherein a perturbation level of the respective set of noise that is added to each input data element to generate the corresponding noised data element is controlled by the timestep value provided for such input data element by the timestep vector;
processing, by the computing system, the plurality of noised data elements with the denoising diffusion model to generate a plurality of predicted noise elements respectively for the plurality of noised data elements; and
modifying, by the computing system, one or more values of one or more parameters of the denoising diffusion model based on a loss function that compares the plurality of predicted noise elements with the sets of noise that were added to the plurality of input data elements.

12. The computing system of claim 11, wherein the computing system is configured to use the denoising diffusion model to perform unconditioned multi-modal data generation.

13. The computing system of claim 11, wherein the computing system is configured to use the denoising diffusion model to perform multi-modal data continuation conditioned on uni-modal or multi-modal conditioning data.

14. The computing system of claim 11, wherein the computing system is configured to use the denoising diffusion model to perform uni-modal or multi-modal data interpolation conditioned on uni-modal or multi-modal conditioning data.

15. The computing system of claim 11, wherein the computing system is configured to use the denoising diffusion model to perform uni-modal.

16. The computing system of claim 11, wherein the computing system is configured to perform classifier-free guidance in which an unconditional run includes fully noising any conditioning data.

17. One or more non-transitory computer-readable media that collectively store a denoising diffusion model that has been trained by the performance of training operations, the training operations comprising:
obtaining, by a computing system comprising one or more computing devices, input data comprising a plurality of input data elements, wherein the plurality of input data elements correspond to at least two different data modalities and at least two different time-slices;
determining, by the computing system, a timestep vector comprising a plurality of timestep values respectively for the plurality of input data elements, wherein the plurality of timestep values comprise at least two different values;
adding, by the computing system, a respective set of noise to each of the plurality of input data elements to generate a plurality of noised data elements, wherein a perturbation level of the respective set of noise that is added to each input data element to generate the corresponding noised data element is controlled by the timestep value provided for such input data element by the timestep vector;
processing, by the computing system, the plurality of noised data elements with the denoising diffusion model to generate a plurality of predicted noise elements respectively for the plurality of noised data elements; and
modifying, by the computing system, one or more values of one or more parameters of the denoising diffusion model based on a loss function that compares the plurality of predicted noise elements with the sets of noise that were added to the plurality of input data elements.

18. The one or more non-transitory computer-readable media of claim 17, wherein the computing system is configured to use the denoising diffusion model to perform unconditioned multi-modal data generation.

19. The one or more non-transitory computer-readable media of claim 17, wherein the computing system is configured to use the denoising diffusion model to perform multi-modal data continuation conditioned on uni-modal or multi-modal conditioning data.

20. The one or more non-transitory computer-readable media of claim 17, wherein the computing system is configured to use the denoising diffusion model to perform uni-modal or multi-modal data interpolation conditioned on uni-modal or multi-modal conditioning data.
